(19) United States
(12) Patent Application Publication
(10) Pub. No.: US 2012/0001853 A1
(43) Pub. Date: Jan. 5, 2012

(54) MEDICAL IMAGE DISPLAY APPARATUS AND MEDICAL IMAGE MANAGEMENT APPARATUS

(76) Inventor: Sho TANAKA, Nasushiobara-shi (JP)

(21) Appl. No.: 13/173,645

(22) Filed: Jun. 30, 2011

(30) Foreign Application Priority Data
Jul. 1, 2010 (JP) 2010-151332

(51) Int. Cl. G06F 3/02

(52) U.S. Cl. 345/168

(57) ABSTRACT

According to one embodiment, a medical image display apparatus includes an input device, a receiver, a display unit, an input unit, and a transmitter. The input device includes a first input key which is provided in the medical image display apparatus. The receiver receives an input key image relating to a second input key provided in the medical image management apparatus from the medical image management apparatus. The display unit displays the received input key image. The input unit operates the displayed input key image in accordance with user's input operation, and generates an operation signal in accordance with the input operation. The transmitter transmits the generated operation signal to the medical image management apparatus.

### CROSS-REFERENCE TO RELATED APPLICATIONS

This application is based upon and claims the benefit of priority from prior Japanese Patent Application No. 2010-151332, filed Jul. 1, 2010, the entire contents of which are incorporated herein by reference.

### FIELD

Embodiments described herein relate generally to a medical image display apparatus and a medical image management apparatus.

### BACKGROUND

Thin client systems have been used increasingly in the medical industry. In a thin client system, a client logs in (on) a server, and perform various processing by mainly using computer resources of the server. A session from logging in the server to logging off the server is the same as physically logging in hardware of the server. It is possible that a single client simultaneously logs in servers.

For example, a client logs in a medical image diagnostic apparatus which is a server, displays a medical image generated by the medical image diagnostic apparatus, and performs various processing through an input device. The input device (keyboard) between the client and the server has, for example, JIS arrangement, QWERTY arrangement, or AZERTY arrangement. When a computer which has a keyboard of a different key arrangement is connected as a client to the server, a virtual keyboard image (hereinafter referred to as “on-screen keyboard image”) which reflects the key arrangement of the keyboard of the server is displayed on a display screen of the client. The on-screen keyboard image reproduces the whole keyboard of the server.

However, the on-screen keyboard image reproduces the whole keyboard on the screen, and thus occupies a large area on the display screen. Therefore, there are cases where the on-screen keyboard covers up the medical image on the display screen, and prevents the user from observing the image. In addition, the medical image diagnostic apparatus is equipped with input keys peculiar to the type of the medical image diagnostic apparatus, separately from the input keys of the keyboard. However, when the server is the medical image diagnostic apparatus, these peculiar input keys cannot be displayed in the on-screen keyboard image.

### BRIEF DESCRIPTION OF THE DRAWINGS

FIG. 1 is a diagram illustrating a network configuration including a medical image display apparatus and medical image management apparatuses according to the present embodiment.

FIG. 2 is a diagram illustrating a structure of each medical image management apparatus illustrated in FIG. 1.

FIG. 3 is a diagram illustrating an example of an external appearance of an input unit of the medical image management apparatus (ultrasonic diagnostic apparatus) of FIG. 2, in a state where a keyboard is pulled out.

FIG. 4 is a diagram illustrating an example of an external appearance of the input unit of the medical image management apparatus (ultrasonic diagnostic apparatus) of FIG. 2, in a state where the keyboard is stored.

FIG. 5 is a diagram illustrating an example of an external appearance of an input unit of the medical image management apparatus (X-ray CT apparatus) of FIG. 2.

FIG. 6 is a diagram illustrating a structure of the medical image display apparatus according to the first embodiment.

FIG. 7 is a diagram illustrating an example of a peculiar key table, which is stored in an input key image storing unit of FIG. 6 and associates input key images relating to peculiar keys with input device information.

FIG. 8 is an example of a keyboard table stored in the input key image storing unit of FIG. 6.

FIG. 9 is a diagram illustrating a typical flow of processing according to the first embodiment.

FIG. 10 is a diagram illustrating an example of an application display image which is displayed by the display unit of FIG. 6.

FIG. 11 is a diagram illustrating a display example of input key images displayed by the display unit of FIG. 6.

FIG. 12 is a diagram illustrating a structure of a medical image display apparatus according to a second embodiment.

FIG. 13 is a diagram illustrating a typical flow of processing according to the second embodiment.

FIG. 14 is a diagram illustrating a display example of a display image displayed by a display unit of FIG. 12.

FIG. 15 is a diagram illustrating a structure of a medical image management apparatus according to a third embodiment.

FIG. 16 is a diagram illustrating a structure of a medical image display apparatus according to the third embodiment.

FIG. 17 is a diagram illustrating a typical flow of processing according to the third embodiment.

FIG. 18 is a schematic diagram of the typical flow of processing according to the third embodiment.

FIG. 19 is a diagram illustrating a structure of a medical image display apparatus according to a fourth embodiment.

FIG. 20 is a diagram illustrating a typical flow of processing according to the fourth embodiment.

### DETAILED DESCRIPTION

In general, according to one embodiment, a medical image display apparatus is connected to a medical image management apparatus through a network such that the medical image display apparatus is capable of logging in the medical image management apparatus. The medical image display apparatus includes an input device, a receiver, a display unit, an input unit, and a transmitter. The input device includes a first input key which is provided in the medical image display apparatus. The receiver receives an input key image relating to a second input key provided in the medical image management apparatus from the medical image management apparatus. The display unit displays the received input key image. The input unit operates the displayed input key image in accordance with user's input operation, and generates an operation signal in accordance with the input operation. The transmitter transmits the generated operation signal to the medical image management apparatus.

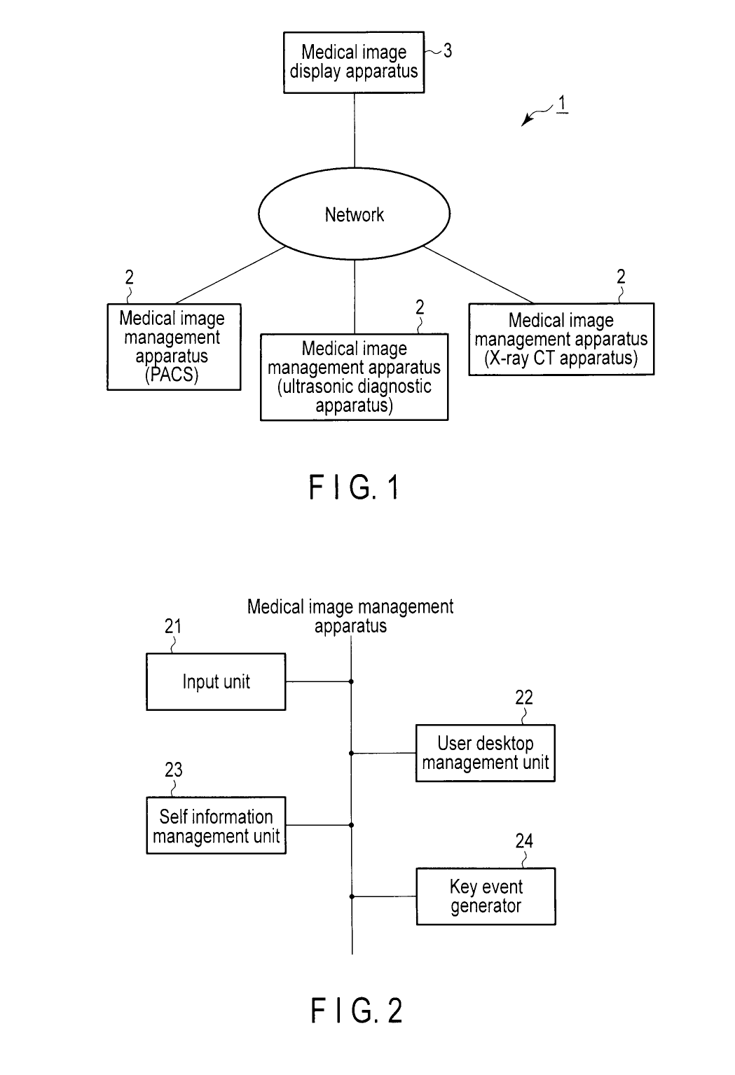

FIG. 1 is a diagram illustrating a configuration of an input assistant system according to the present embodiment. As illustrated in FIG. 1, the input assistant system 1 is formed of medical image management systems 2 and a medical image display apparatus 3, which are connected through a network. The input assistant system 1 realizes a thin client system. The network is formed as, for example, a LAN (local area network) based on Ethernet (Registered Trademark). Communications through the network are performed based on a communication protocol such as TCP/IP.

As is well known, functions of thin client systems are classified broadly into a remote desktop (terminal service) function and a remote console function.

The remote desktop function is realized by, for example, Remote_Desktop of Windows (Registered Trademark) or terminal service of Windows (Registered Trademark) 2000, which are basic software (OS: operating system) of Microsoft Corporation. Communications between the medical image display apparatus 3 and the medical image management apparatuses 2 are defined by Remote_Desktop_Protocol (RDP). By using the RDP, the medical image display apparatus 3 transmits an operation signal in accordance with input operation by the user to the medical image management apparatuses 2, and the medical image management apparatuses 2 transmit screen image data to the medical image display apparatus 3.

The remote console function is realized by software, which causes the screen image of the medical image management apparatus 2 to be displayed on the medical image display apparatus 3 and operated from the medical image display apparatus 3 by remote control, not generating a new desktop. This function is also divided between the medical image management apparatuses 2 and the medical image display apparatus 3, and software of the apparatuses provides these functions while performing communication between them.

The input assistant system 1 according to the present embodiment improves convenience of input operation in the clientes in a thin client system. The input assistant system 1 according to the present embodiment will be explained hereinafter with reference to a first embodiment and a second embodiment.

### First Embodiment

FIG. 2 is a diagram illustrating a structure of a server 2 of an input assistant system 1 according to a first embodiment. Each medical image management apparatus 2 functions as a server of the thin client system. Each medical image management apparatus 2 is referred to as “server” hereinafter. For example, a medical image storing apparatus such as PACS (picture archiving and communication system) corresponds to the server 2. In addition, a medical image diagnostic apparatus such as an ultrasonic diagnostic apparatus, an X-ray computer tomographic apparatus (X-ray CT apparatus), a magnetic resonance imaging apparatus (MRI apparatus), a PET apparatus, and a SPECT apparatus also corresponds to the server 2. The servers 2 are connected to a network such that a client 3 can log in each server 2 through the network. To specifically perform the following explanation, suppose that each server 2 is a medical image diagnostic apparatus.

As illustrated in FIG. 2, each server 2 includes an input unit (console) 21, a user desktop management unit 22, a self information management unit 23, and a key event generator 24.

The input unit 21 includes an input device such as a keyboard, which is provided with input keys. The input keys are arranged in accordance with the standard of the keyboard. The standard of the keyboard includes, for example, JIS arrangement, QWERTY arrangement, and AZERTY arrangement. In addition, the unit 21 includes various input keys which are peculiar to a modality type of itself (hereinafter referred to as “peculiar keys”) and configured to receive operation peculiar to the modality type of its own device. The unit 21 generates an operation signal in accordance with operation of the input keys by the user.

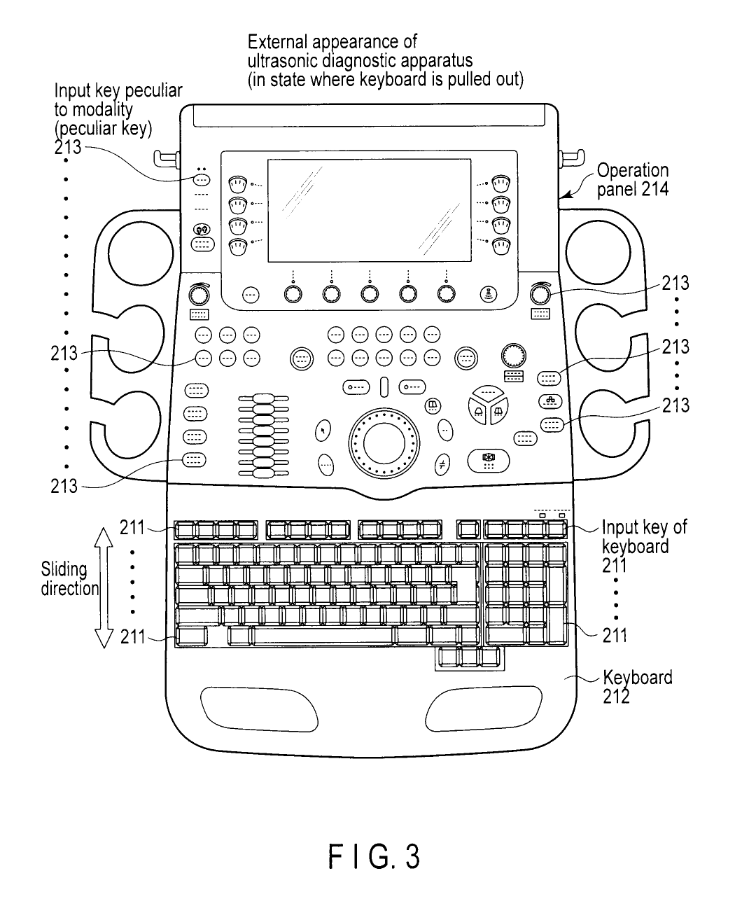

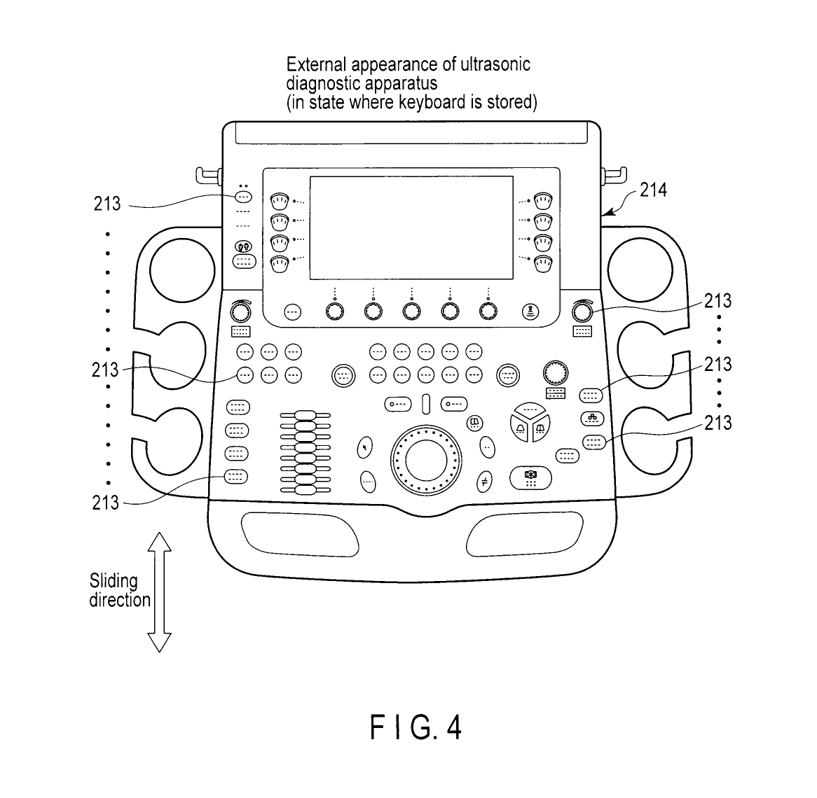

FIG. 3 is a diagram illustrating an external appearance of the input unit 21 of an ultrasonic diagnostic apparatus. As illustrated in FIG. 3, the unit 21 of the ultrasonic diagnostic apparatus includes a keyboard 21, in which various input keys 211 are arranged, and an operation panel 21 which is provided with various peculiar keys 213. The peculiar keys 213 are input keys which are mounted for ultrasonic scanning and ultrasonic image processing. The keyboard 212 is slidable. Thereby, the user can pull out the keyboard 212 from the housing of the ultrasonic diagnostic apparatus as illustrated in FIG. 3, and store the keyboard 212 into the housing of the ultrasonic diagnostic apparatus as illustrated in FIG. 4.

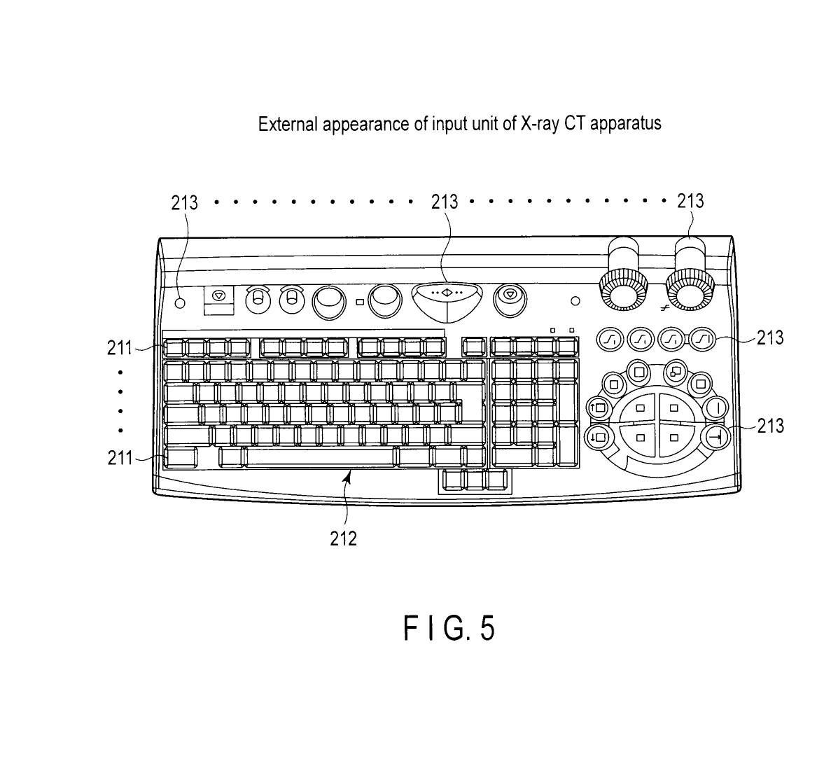

FIG. 5 is a diagram illustrating an external appearance of the unit 21 of an X-ray CT apparatus. As illustrated in FIG. 5, a keyboard 212 and various peculiar keys 213 are arranged on an operation table (console) of the unit 21 of the X-ray CT apparatus. The peculiar keys 213 are input keys which are mounted for CT scanning and CT image processing.

In accordance with a remote access request transmitted from a client 3, the user desktop management unit 22 generates a virtual user desktop for the client 3, and manages the generated user desktop. Simultaneously, the unit 22 generates communication session information for identifying a session from login to logoff, and manages the generated communication session information. While a communication session is held, the unit 22 transmits screen image data of the user desktop of the server 2 to the client 3. Specifically, the unit 22 functions as a transmitter which transmits screen image data to the client 3.

The self information management unit 23 stores an identifier of the input device of itself (more specifically, input unit 21), and application identifiers. The identifier of the input device relating to the server 2 is hereinafter referred to as “server input device identifier”. The unit 23 transmits the server input device identifier and the application identifier to the client 3. The application identifier is an identifier of application which is executed by the server 2 in accordance with an instruction from the client 3. The input device identifier includes at least one of information relating to the standard of the keyboard 212 which the server itself is equipped with, and information relating to the type of the server itself. The standard of the keyboard is, for example, JIS arrangement, QWERTY arrangement, and AZERTY arrangement. A thumb-shift keyboard (NICOLA keyboard) may be used as the standard of the keyboard. The information relating to the type of the server itself indicates the type of modality such as an ultrasonic diagnostic apparatus, an X-ray CT apparatus, an MRI apparatus, a PET apparatus, and a SPECT apparatus. The product name may be used as the information relating to the type of the server itself. As described above, the unit 23 functions as a transmitter which transmits the server input device identifier and the application identifier to the client 3.

The key event generator 24 generates a key event which corresponds to an operation signal from the client 3. By generation of the key event, processing in accordance with the user's instruction is executed by the server 2.

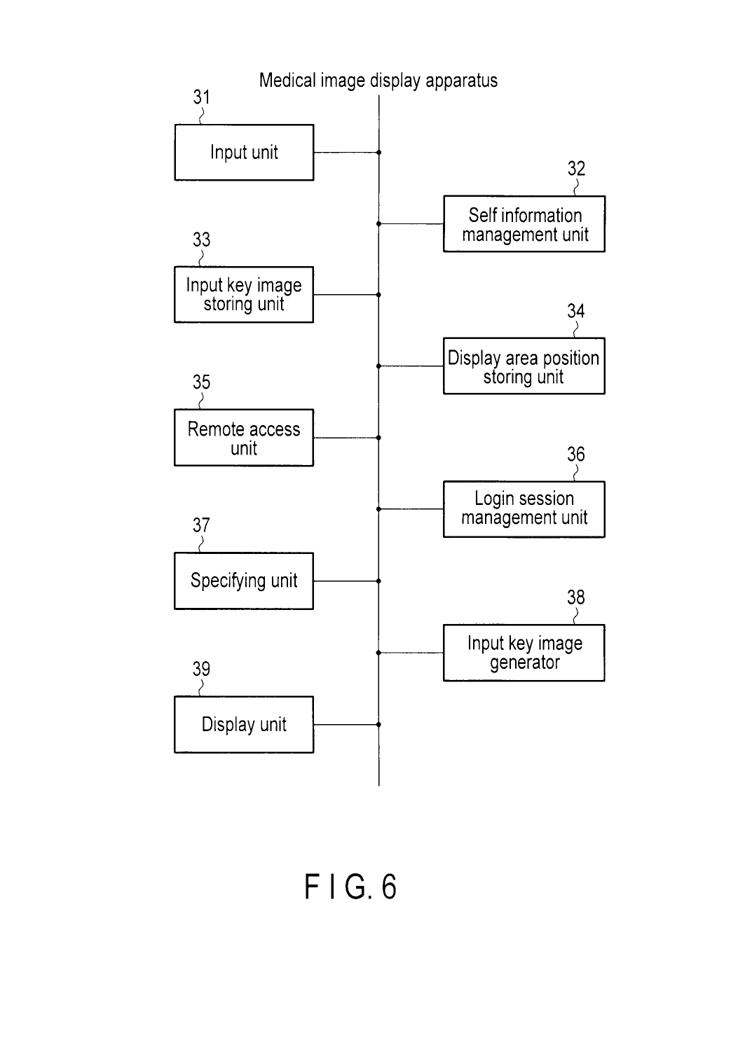

FIG. 6 is a diagram illustrating a structure of the medical image display apparatus 3. The medical image display apparatus 3 functions as a client of the thin client system. The medical image display apparatus is hereinafter referred to as “client”. The client 3 is realized by, for example, a computer apparatus which is called “viewer”. The client 3 is connected to the servers 2 on the network such that the client 3 can simultaneously log in the servers 2.

As illustrated in FIG. 6, the client 3 includes an input unit 31, a self information management unit 32, an input key image storing unit 33, a display area position storing unit 34, a remote access unit 35, a login session management unit 36, a specifying unit 37, an input key image generator 38, and a display unit 39.

The input unit 31 includes an input device such as a keyboard and a mouse, which is provided on the computer apparatus. Input keys included in the keyboard are arranged in accordance with the keyboard standard of the apparatus (in other words, the client 3). The unit 31 generates an operation signal in accordance with an input operation of the input keys by the user. In addition, the unit 31 operates an input key image displayed by the display unit 39 in accordance with user's input operation through the input device, and generates an operation signal in accordance with the input operation.

The self information management unit 32 stores an identifier relating to the input device of the client 3 (more specifically, the input unit 31). The identifier relating to the input device of the client 3 is hereinafter referred to as “client input device identifier”.

The input key image storing unit 33 stores the input device identifier in association with each of input key images. The input key images are images which imitate respective input keys. The input key images are displayed as GUI (graphical user interface) on the display unit 39. Corresponding operation signals are assigned to the respective input key images.

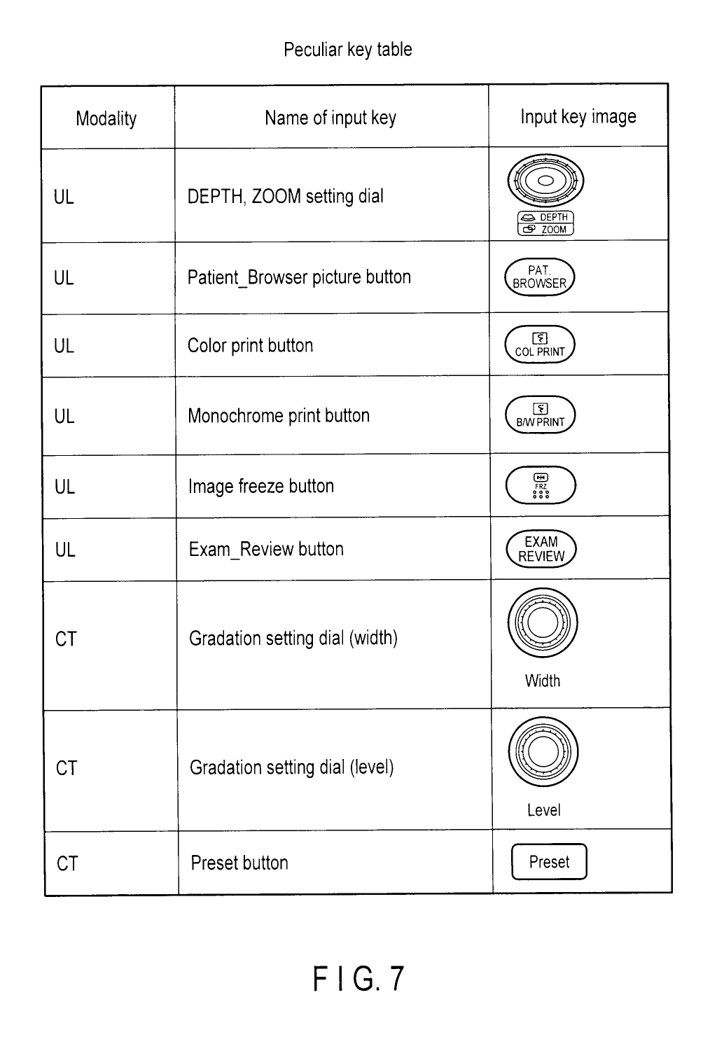

FIG. 7 is a diagram illustrating an example of a peculiar key table which is stored in the input key image storing unit 33. The peculiar key table is a table which correlates input key images relating to the peculiar keys with input device information. As illustrated in FIG. 7, the peculiar key table includes the item “type of the server (modality)”, the item “name of the input key”, and the item “input key image”. The item “type of modality” shows an identifier which indicates the type of the modality which includes the corresponding input key. The type of the modality is, for example, UL (ultrasonic diagnostic apparatus) or CT (X-ray CT apparatus). The item “name of the input key” shows the name of the input key corresponding to the input key image. The input key image is an image which corresponds to an input key which may be used by the client 3. The input key image has an initial size and form. For example, as input key images for the ultrasonic diagnostic apparatus, prepared are “DEPTH, ZOOM setting dial”, “Patient_Browser picture button”, “color print button”, “monochrome print button”, “image freeze button”, and “Exam_Review button”. In addition, “gradation setting dial (width”, “gradation setting dial (level)”, and “Preset button” are prepared as input key images for the X-ray CT apparatus.

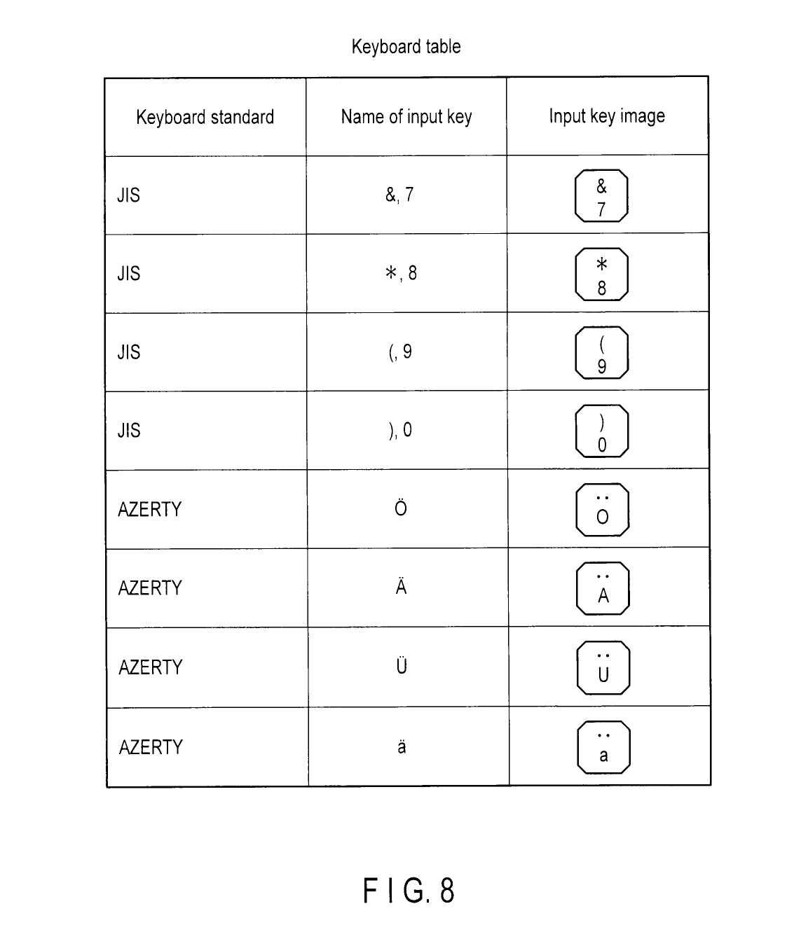

FIG. 8 is a diagram illustrating an example of a keyboard table which is stored in the input key image storing unit 33. The keyboard table is a table which correlates input key images relating to the input keys of the keyboard with identification information items of the standard of the keyboard. As illustrated in FIG. 8, the keyboard table includes, for example, the item “name of the keyboard standard”, the item “name of the input key”, and the item “input key image”. The name of the keyboard standard is, for example, the standard name such as “JIS”, “QWERTY”, “AZERTY”, and “Thumb shift keyboard”. The name of the input key is, for example, a name of the input key which corresponds to the input key image. In addition, the input key image is an image which corresponds to the input key. Each input key image has an initial size and shape. For example, as input key images of the JIS standard, input key images which are peculiar to the JIS standard such as “&, 7”, “*, 8”, “(, 9” and “), 0” are prepared. In addition, as input key images of the AZERTY standard, input key images peculiar to the AZERTY standard such as “Ö”, “Ä”, “Ü”, and “ä” are prepared.

The display area position storing unit 34 stores identifiers of applications in association with medical image display area positions. The medical image display area position is a position of a display area of a medical image on a display screen. The medical image display area position differs according to the type of the application. As the application relating to the present embodiment, various applications which display medical images are applicable. For example, the application includes an image viewer application relating to an ultrasonic diagnostic apparatus, an image viewer application relating to an X-ray CT apparatus, and an application relating to heart function analysis.

The remote access unit 35 transmits a remote access request to the server 2. In addition, the unit 35 transmits an operation signal generated by the input unit 31. As described above, the unit 35 functions as a transmitter which transmits a remote access request and an operation signal.

The login session management unit 36 receives login session information between the server 2 and the client 3. The unit 36 holds the received login session information. The unit 36 also receives the server input device identifier and the application identifier from the server 2. The unit 36 holds the received server input device identifier and the application identifier. As described above, the unit 36 functions as a receiver of the server input device identifier and the application identifier.

The specifying unit 37 searches the display area position storing unit 34, by using the application identifier from the server 2 as a searching key, and specifies a medical image display area position which is correlated with the searching key.

The input key image generator 38 extracts at least one input key image to be displayed from the input key image storing unit 33, based on the server input device identifier transmitted from the server 2 and the client input device identifier of the client 3 itself. The input key image to be displayed is an input key image that corresponds to an input key which is not included in the apparatus 3 (more specifically, input unit 31) but included in the server 2 in which the apparatus 3 logs. In addition, the generator 38 subjects the extracted input key image to image processing such as enlargement, reduction, and deformation, if necessary. Besides, when input key images are extracted, the generator 38 may generate an input key arrangement image based on the extracted input key images. The input key arrangement image is an image in which the extracted input key images are arranged. As described above, the generator 38 functions as an extractor of the input key image, and a generator of the input key arrangement image.

The display unit 39 displays the input key image and the input key arrangement image. In display, the display unit 39 displays the input key images and the input key arrangement image in a position on the display screen other than the medical image display area position specified by the specifying unit 37. When input key images are extracted by the input key image generator 38, the display unit 39 may display the input key images in a position other than the medical image display area position.

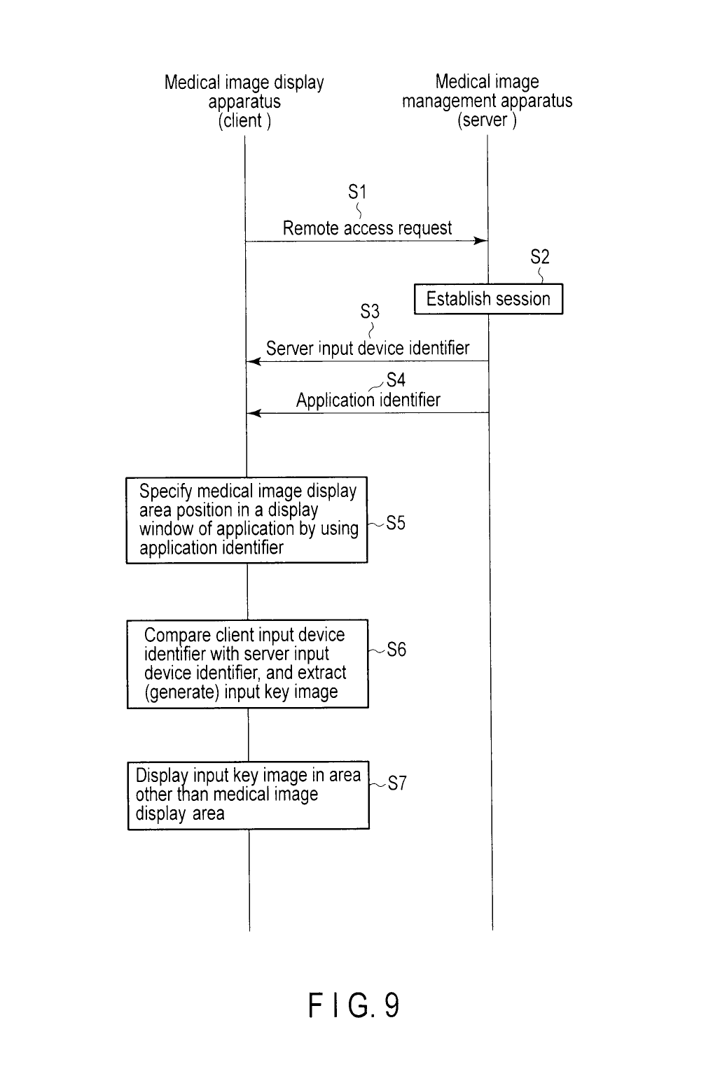

Next, an operation example of the input assistant system 1 according to the first embodiment will be explained hereinafter. FIG. 9 is a diagram illustrating a flow of processing of the input assistant system 1 according to the first embodiment. As illustrated in FIG. 9, the user performs login operation through the input unit 31 of the client 3. When the login operation is performed, the remote access unit 35 transmits a remote access request to the server 2 designated by the user (S1).

When S1 is performed, the user desktop management unit 22 determines whether the transmitted remote access request is valid or not. When the user desktop management unit 22 determines that the request is valid, the user desktop management unit 22 permits the user to access the server 2. When access is not permitted, the user desktop management unit 22 transmits information to notify the user thereof to the client. On the other hand, when access is permitted, the user desktop management unit 22 establishes a login session for the user, and generates login session information (S2). While the communication session is held, the user desktop management unit 22 transmits screen image data of the user desktop of the server 2 to the client 3. The screen image data is received by the login session management unit 36. A screen image which corresponds to the received screen image data is displayed on the display unit 39.

After S2, the self information management unit 23 transmits the server input device identifier of the server 2 to the client 3 (S3). The transmitted server input device identifier is received by the login session management unit 36.

After S3, when an application is used by the client 3, the self information management unit 23 transmits an application identifier of the application which is in operation to the client 3 (S4). The transmitted application identifier is received by the login session management unit 36.

After S4, the specifying unit 37 searches the medical image display area position storing unit 34 by using the received application identifier as a searching key, and specifies a medical image display area position correlated with the searching key (S5). Then, the specifying unit 37 sets an input key image display area in accordance with the specified medical image display area position. The input key image display area is an area which is located on a window relating to the application which is in operation, and in a position other than the specified medical image display area position.

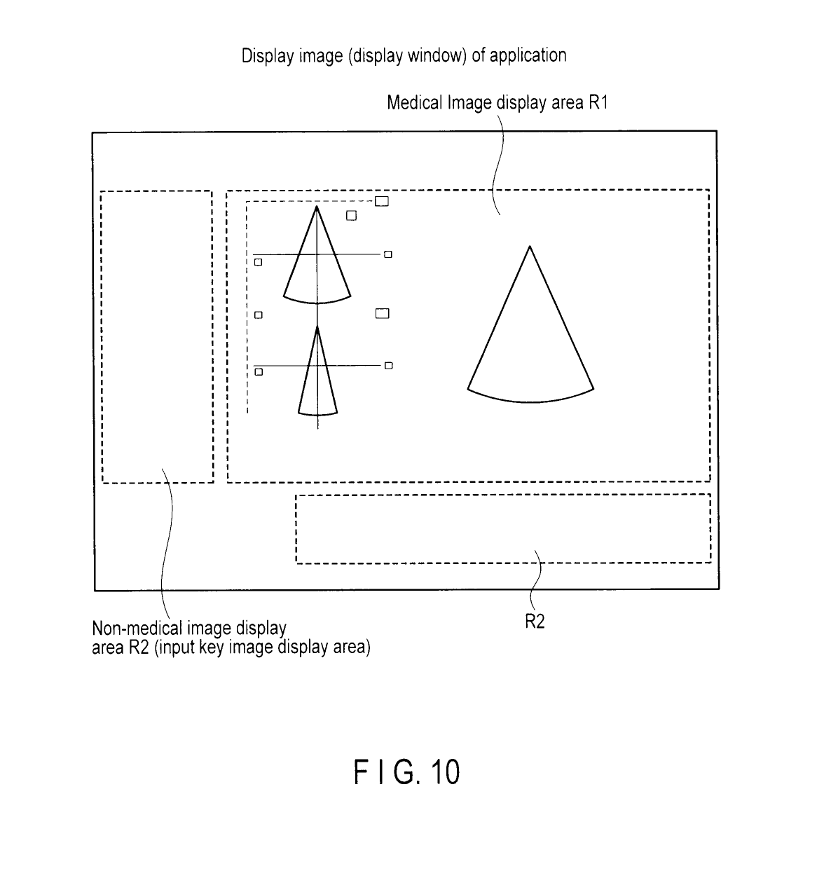

FIG. 10 is a diagram illustrating an example of a display image of an application. The application illustrated in FIG. 10 is an image viewer application relating to an ultrasonic diagnostic apparatus. The display image (display window) of the application includes a medical image display area R1 and a non-medical image display area (that is, input key image display area) R2. The position of the area R1 is stored in the medical image display area position storing unit 34 in association with the application identifier. At S5, first, the position of the area R1 is specified. Next, an area of a position other than the area R1 is set as the area R2. When the size of the area R2 is smaller than the size of the area occupied by the input key image to be displayed, the area should be excluded from the R2. In addition, when there are input key image display areas R2, one area R2 which should display the input key image may be automatically designated or designated by the user as desired through the input unit 31.

In the above processing, only the medical image display area is considered when the area R2 is set. However, the present embodiment is not limited to it, but the area R2 may be set to avoid another display area (for example, a display area of parameters which are important for diagnosis) as well as the medical image display area.

After S5, the input key image generator 38 reads out the server input device identifier from the login session management unit 36, and reads out the client input device identifier from the self information management unit 32. Then, the input key image generator 38 compares the server input device identifier with the client input device identifier, and extracts at least one input key image to be displayed from the input key image storing unit 33 (S6). The input key image to be displayed is an input key image that corresponds to an input key which is not included in the client 3 but included in the server 2. For example, the keyboard standard of the client 3 is different from the keyboard standard of the server 2, the input key image which corresponds to an input key which is peculiar to the keyboard standard of the server 2 is extracted. In addition, typically, since the client 3 is not a medical image diagnostic apparatus, an input key image which corresponds to an input key peculiar to the modality type of the server 2 is also extracted.

For example, when the client 3 logs in the ultrasonic diagnostic apparatus 2, input key images which correspond to the input keys “DEPTH, ZOOM setting dial”, “Patient_Browser picture button”, “color print button”, “monochrome print button”, “image freeze button”, and “Exam_Review button” as illustrated in FIG. 7 are extracted. After extraction, it is preferable that the input key image generator 38 subjects the extracted input key image to image processing such as enlargement, reduction, and deformation, in accordance with, for example, the size of the area R2. When no image processing is necessary, the initial input key image is used as the input key image for display. When input key images are extracted, the input key image generator 38 may generate an input key arrangement image based on the input key images.

After S6, the display unit 39 displays the input key image and/or the input key arrangement image on the input key image display area (S7). The input key image is displayed as GUI which can be operated by the input unit 31.

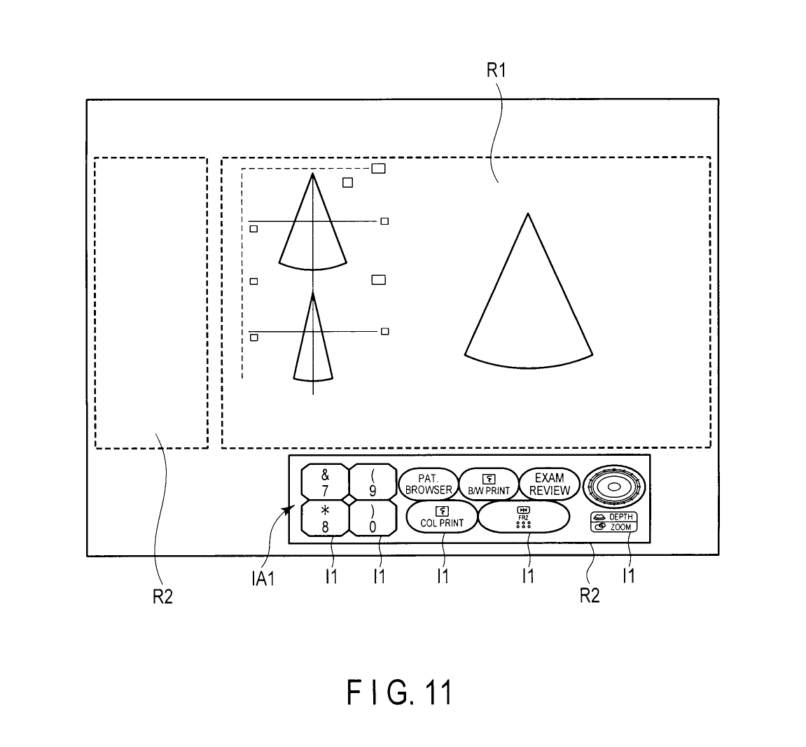

FIG. 11 is a diagram illustrating a display example of input key images I1 and an input key arrangement image IA1 displayed on the display unit 39. As illustrated in FIG. 11, the input key images I1 and the input key arrangement images IA1 are displayed in the area R2, not the area R1.

In prior art, when the key board mounted to the server is different from the keyboard mounted to the client, an on-screen key image which schematically indicates the whole keyboard of the server is displayed on the display of the client. In addition, in prior art, there are cases where input keys which are mounted to the client are also unnecessarily displayed on the display unit of the client. Therefore, the on-screen key image occupies a comparatively large area of the display screen, and displaying the on-screen key image is rather an obstacle than a help to observation of the medical image.

According to the input assistant system 1 according to the present embodiment, an input key image relating to an input key which is mounted to the client 3 but mounted to the server 2 can be displayed on the display unit 39 of the client 3. Therefore, the input keys mounted to the client 3 do not overlap in function the input key images displayed on the display unit 39. In addition, the input assistant system 1 according to the present embodiment can display the input key image in an area other than the medical image display area in the application which is in operation. Therefore, the input assistant system 1 according to the present embodiment can display the input key image in a display form which does not prevent the user from observing the medical image.

In addition, each server includes peculiar keys which are peculiar to the type of the server. However, in prior art, there is no method of displaying input key images corresponding to the peculiar keys in the client, and operability of operation corresponding to the peculiar keys is very poor.

The input assistant system 1 according to the present embodiment stores input key images corresponding to the peculiar keys in advance, and thus can display input key images corresponding to the peculiar keys which are not mounted to the client 3. Therefore, the input assistant system 1 can simply realize operations corresponding to the peculiar keys by operation of the input key images.

As described above, displaying input key images corresponding to input keys which are not mounted to the client but mounted to the server can prevent an erroneous diagnosis due to difference in input device between the client and the server.

When the application is changed by the user through the input unit 31 of the client 3, the user desktop management unit 22 of the server 2 transmits an application identifier of the new application after change to the client 3. In this case, S S3 to S7 are performed again.

When input operation is performed for the input key image by the user through the input unit 31 while the application is in operation, the remote access unit 35 transmits an operation signal, which is assigned to the input key image for which the input operation is performed, to the server 2. The key event generator 24 generates a key event which corresponds to the transmitted operation signal. Thereby, processing which corresponds to the input operation performed for the input key image is executed in the server 3.

The operation example of the input assistant system 1 according to the first embodiment is as described above.

According to the first embodiment described above, it is possible to improve convenience of input operation in the client in the thin client system.

### Second Embodiment

Next, an input assistant system according to a second embodiment will be explained hereinafter. In the following explanation, constituent elements which have almost the same functions as those of the first embodiment are denoted by the same respective reference numerals, and explained again only if necessary. Suppose that the client according to the second embodiment logs in servers through a network. Suppose that the number of the servers which the client logs in is two for specifically performing the following explanation, although it may be of any number. In addition, each server has the same structure as that of the first embodiment.

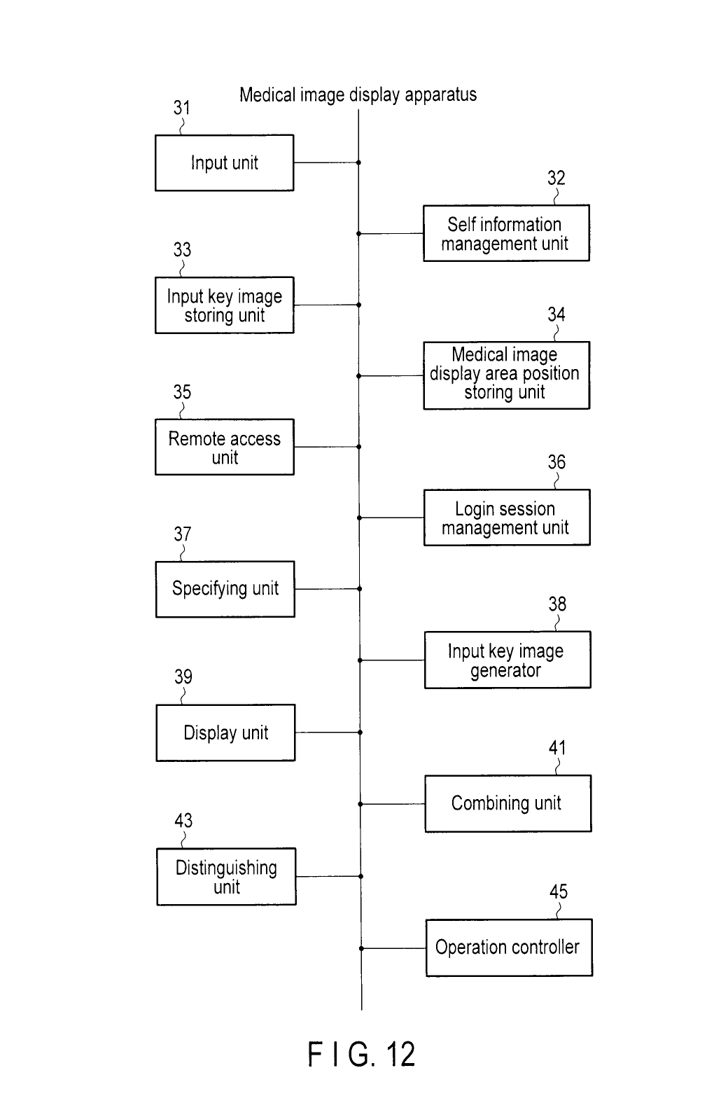

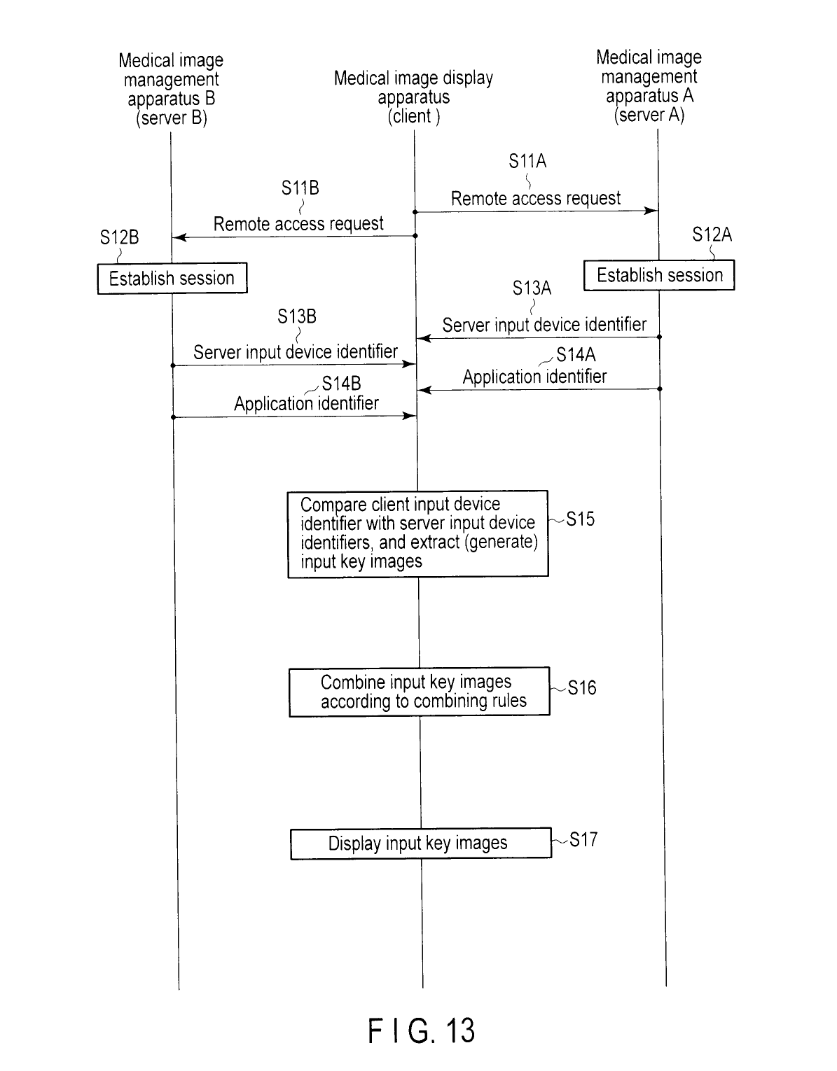

FIG. 12 is a diagram illustrating a structure of a client 3 according to the second embodiment. FIG. 13 is a diagram illustrating a typical flow of processing of the input assistant system according to the second embodiment.

First, access to a server A will be explained hereinafter. As illustrated in FIG. 13, the user performs login operation through an input unit 31 of the client 3. The remote access unit 35 transmits a remote access request to the server A designated by the user (S11A). A user desktop management apparatus 22 of the server A determines whether the remote access request is valid or not, and permits the user's access when it determines that the remote access request is valid. Then, the user desktop management unit 22 of the server A establishes a login session for the user, and generates login session information (S12A). While the communication session is held, the user desktop management apparatus 22 of the server A transmits screen image data of the user desktop relating to the server A to the client 3. The screen image data relating to the server A is received by a login session management unit 36. A screen image which relates to the server A and corresponds to the received screen image data is displayed on a display unit 39. A self information management unit 23 of the server A transmits a server input device identifier of the server A to the client 3 (S13A). In addition, the self information management unit 23 transmits an application identifier of the application which is in operation to the client 3 (S14A).

Access to a server B is performed in the same manner. Specifically, the remote access unit 35 transmits a remote access request to a server B designated by the user (S11B). A user desktop management apparatus 22 of the server B determines whether the remote access request is valid or not, and permits the user's access when it determines that the remote access request is valid. Then, the user desktop management unit 22 of the server B establishes a login session for the user (S12B). While the communication session is held, the user desktop management apparatus 22 of the server B transmits screen image data of the user desktop relating to the server B to the client 3. The screen image data relating to the server B is received by the login session management unit 36. A screen image which relates to the server B and corresponds to the received screen image data is displayed on the display unit 39. A self information management unit 23 of the server B transmits a server input device identifier of the server B to the client 3 (S13B). In addition, the self information management unit 23 of the server B transmits an application identifier of the application which is in operation to the client 3 (S14B).

The login session management unit 36 of the client 3 receives the login session information between the client 3 and the server A from the server A, and receives login session information between the client 3 and the server B from the server B. The received login session information items are held in the login session management unit 36.

After S14A and S14B, the input key image generator 38 extracts input key images to be displayed from an input key image storing unit 33, by using the server input device identifier of the server A, the server input device identifier of the server B, and the client input device identifier (S15). The input key images to be displayed are input key images that correspond to input keys which are mounted to one of the server A and the server B and not mounted to the client 3.

Specific processing of S15 will be explained hereinafter. First, the input key image generator 38 extracts at least one first to-be-displayed input key image from the input key image storing unit 33, by using the server input device identifier of the server A and the client input device identifier. The first to-be-displayed input key image is an input key image that corresponds to an input key which is mounted to the server A and not mounted to the client 3. When first to-be-displayed input key images are extracted, the input key image generator 38 generates a first input key arrangement image based on the first to-be-displayed input key images. The first input key arrangement image includes the first to-be-displayed input key images. In the same manner, the input key image generator 38 extracts at least one second to-be-displayed input key image from the input key image storing unit 33, by using the server input device identifier of the server B and the client input device identifier. The second to-be-displayed input key image is an input key image that corresponds to an input key which is mounted to the server B and not mounted to the client 3. When second to-be-displayed input key images are extracted, the input key image generator 38 generates a second input key arrangement image based on the second to-be-displayed input key images. The second input key arrangement image includes the second to-be-displayed input key images.

After S15, a combining unit 41 combines the input key images in accordance with fixed rules (hereinafter referred to as “combining rules”) (S16). In combining, server access number information is used. The server access number information is managed by the login session management unit 36. For example, when a pair of the same input key images is included in the first input key arrangement image and the second input key arrangement image, combining processing is performed by the combining unit 41. In the combining processing, the combining unit 41 generates a combined input key arrangement image based on the first input key arrangement image and the second input key arrangement image. The combined input key arrangement image includes one input key image among a pair of the same input key images included in the first input key arrangement image and the second input key arrangement image. As described above, the combining unit 41 combines a pair of the same input key images into a single input key image. In other words, when there is a pair of the same input key images, only one of the same input key images is adopted. As described above, the combining unit 41 functions as a generator of the combined input key arrangement image.

Specifically, suppose that both the server A and the server B have the AZERTY arrangement, and the client 3 has the JIS arrangement. In this case, the login session management unit 36 manages server access number information that the client 3 accesses to the two servers 2. At S15, two input key images (for example, input key images relating to “Ö” in FIG. 8) which are the same as each other and peculiar to the AZERTY arrangement are extracted. Then, at S16, one of the two input key images is removed and the other is adopted, to prevent display of the two input key images of the same type.

After S16, the display unit 39 displays the combined input key arrangement image in an empty area in the display screen (S17). When the client 3 logs in servers, the display unit 39 displays user desktops which correspond to the respective servers 2 on the display screen. For example, the display unit 39 displays the combined input key arrangement image in an area (empty area) where no user desktop images are displayed in the display screen. Thereby, input key images included in the combined input key arrangement image are displayed.

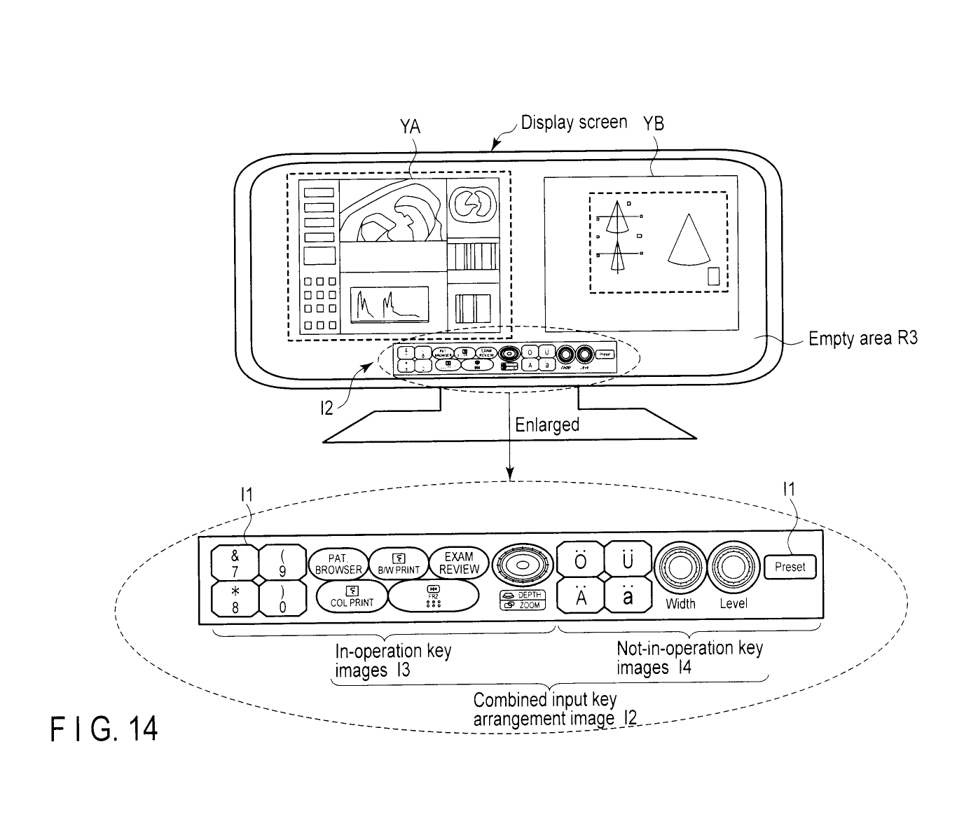

FIG. 14 is a diagram illustrating a display example of the combined input key arrangement image. As illustrated in FIG. 14, the display unit 39 displays a user desktop image YA which corresponds to the server A, and a user desktop image YB which corresponds to the server B. Typically, the display screen is not filled up with the user desktop image YA and the user desktop image YB, but includes an empty area where no user desktop image is displayed. The combined input key arrangement image I2 is displayed in the empty area. The combined input key arrangement image I2 includes input key images I1 which relate to input keys mounted to the server A, and input key images I1 which relate to input keys mounted to the server B. Displaying the combined input key arrangement image I2 in an empty area R3 improves the visibility of the input key images I1. When the display screen includes no empty area R3, the display unit 39 displays the combined input key arrangement image I2, avoiding the medical image display area specified by the specifying unit 37, as explained in the first embodiment.

As illustrated in FIG. 14, the display unit 39 may visually emphasize the user desktop image YA which corresponds to the server 2 which is in operation. For example, the display unit 39 visually emphasizes the user desktop image YA corresponding to the server 2 in operation, by enclosing the user desktop image YA by a colored frame. The color of the frame can be set to a desired color by the user through the input unit 31. As another example, the display unit 39 may blink on and off the frame of the user desktop image YA which corresponds to the server 2 in operation. As another example, the display unit 39 may display the frame of the user desktop image YA corresponding to the server 2 in operation with a color which is different from the color of the frame of the user desktop image corresponding to the server 2 which is not in operation. By visually emphasizing the user desktop image in operation, the user can easily distinguish the user desktop image in operation from the displayed user desktop images.

To distinguish the server in operation from the server not in operation, the client 3 includes a distinguishing unit 43. The distinguishing unit 43 distinguishes the server in operation from the server not in operation among the servers which the client logs in. The term “in operation” means that the task of the application is being executed, and the term “not in operation” means that the task of the application is not being executed.

As illustrated in FIG. 14, the display unit 39 can visually distinguish in-operation key images I3 from not-in-operation key images I4. The in-operation key images I3 are input key images which correspond to input keys mounted to the server in operation, among the input key images I1. The not-in-operation key images I4 are input key images which correspond to input keys mounted only to the server 2 not in operation, among the input key images I1. To visually distinguish the key images, the display unit 39 visually emphasizes the in-operation key image I3, and visually suppresses the not-in-operation key image I4. For example, the display unit 39 darkens the not-in-operation key images I4 to visually suppress the not-in-operation key images I4, and brightens the in-operation key images I3 to visually emphasize the in-operation key images I3. In addition, the display unit 39 may display the in-operation key images I3 and the not-in-operation key images I4 with different colors or different grey levels. As another example, the display unit 39 may eliminate the not-in-operation key images I4 from the display screen, and display only the in-operation key images I3. As described above, visually distinguishing the in-operation key images I3 from the not-in-operation key images I4 can prevent the user from erroneously operating the input key images.

To further reduce occurrence of operation errors by the user, the client 3 includes an operation controller 45. The operation controller 45 nullifies user operations for the not-in-operation key images I4, and makes user operations for the in-operation key images I3 valid. It can be set as desired by the user through the input unit 31 whether to operate the operation controller 45 or not.

The explanation of the above processing shows that combining processing is performed by the combining unit 41, when a pair of input key images of the same type is included in the first input key arrangement image and the second input key arrangement image. However, the combining processing by the combining unit 41 may not be necessarily performed. It can be set as desired by the user through the input unit 41 whether the combining processing by the combining unit 41 is performed or not. When the combining processing is not performed, the display unit 39 displays the first input key arrangement image relating to the server A and the second input key arrangement image relating to the server B.

In such a case, the display unit 39 displays a first screen image in visual association with the first input key arrangement image corresponding to the server A, and displays a second screen image in visual association with the second input key arrangement image corresponding to the server B. For example, the first input key arrangement image is displayed in the vicinity of the first screen image. Specifically, the first input key arrangement image is preferably displayed above, below, on the left or the right of the first screen image. In the same manner, the second input key arrangement image is displayed in the vicinity of the second screen image. Specifically, the second input key arrangement image is preferably displayed above, below, on the left or the right of the second screen image. As described above, the screen image and the input key arrangement image which correlate with each other are displayed in visual association with each other, and thereby operability of the screen image by the input key arrangement image can be improved.

In addition, the display unit 39 arranges the first input key arrangement image and the second input key arrangement image in accordance with the arrangement (vertical or horizontal) of the first screen image and the second screen image.

The explanation of the operation example of the input assistant system 1 according to the second embodiment is as described above.

As described above, according to the second embodiment, it is possible to improve convenience of input operation in the client in the thin client system.

### Third Embodiment

The servers 2 according to the first embodiment do not generate input key images. Servers 2 according to a third embodiment generate input key images. The following is explanation of servers and a client according to the third embodiment. In the following explanation, constituent elements which have almost the same functions as those in the first embodiment are denoted by the same respective reference numerals, and explained again only if necessary.

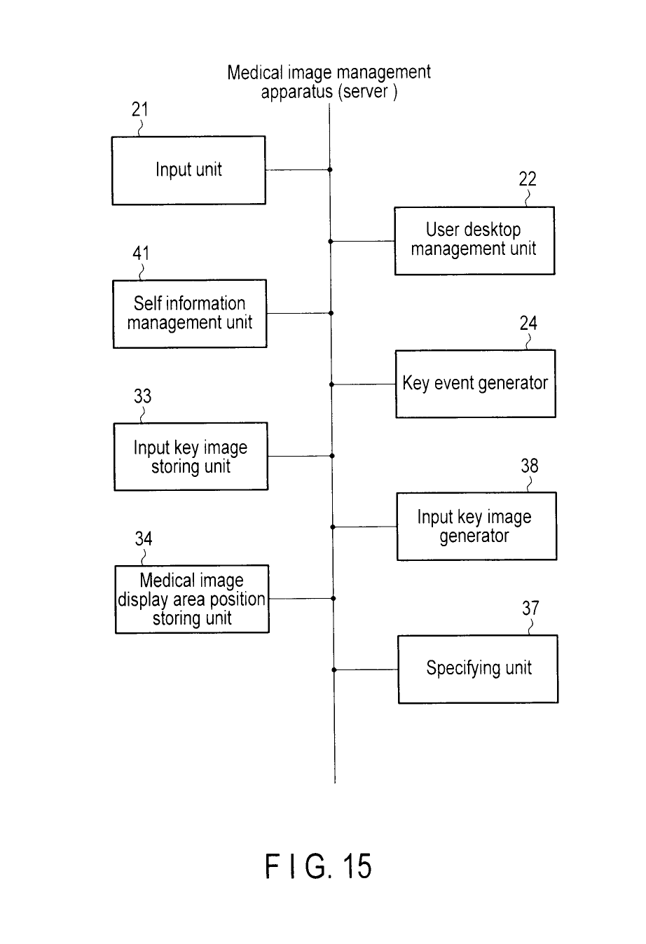

FIG. 15 is a diagram illustrating a structure of a medical image management apparatus (server) 2 according to the third embodiment. As illustrated in FIG. 15, the server 2 comprises an input unit 21, a user desktop management unit 22, a self information management unit 41, a key event generator 24, an input key image storing unit 33, an input key image generator 38, a medical image display area position storing unit 34, and a specifying unit 37.

The self information management unit 41 stores a server input device identifier and application identifiers. The self information management unit 41 functions as a receiver which receives a client input device identifier from the client 3. The self information management unit 41 also functions as a transmitter which transmits data of a medical image display area position to the client 3.

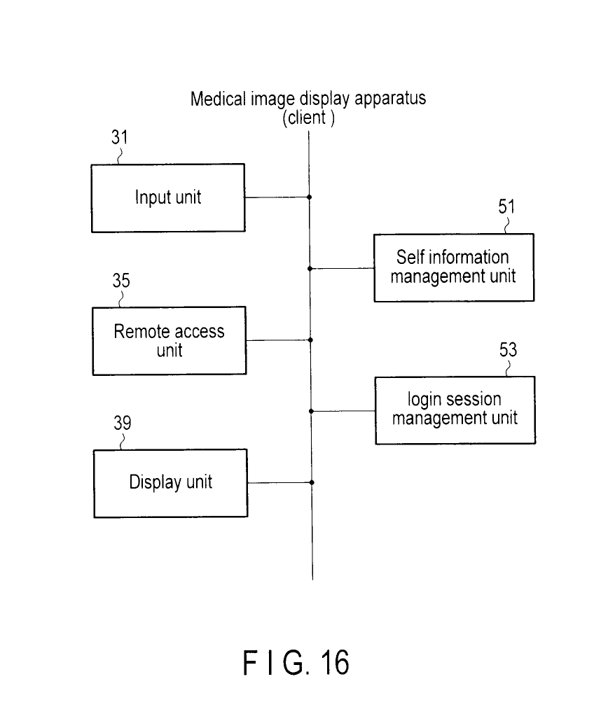

FIG. 16 is a diagram illustrating a structure of a medical image display apparatus (client) 3 according to the third embodiment. As illustrated in FIG. 16, the client 3 comprises an input unit 31, a self information management unit 51, a remote access unit 35, a login session management unit 53, and a display unit 39.

The self information management unit 51 stores a client input device identifier. The self information management unit 51 functions as a transmitter which transmits the client input device identifier to the server 2.

The login session management unit 53 receives login session information between the server 2 and the client 3. The login session management unit 53 holds the received login session information. The login session management unit 53 functions as a receiver which receives input key images from the server 2. The login session management unit 53 also functions as a receiver which receives data of a medical image display area position from the server 2.

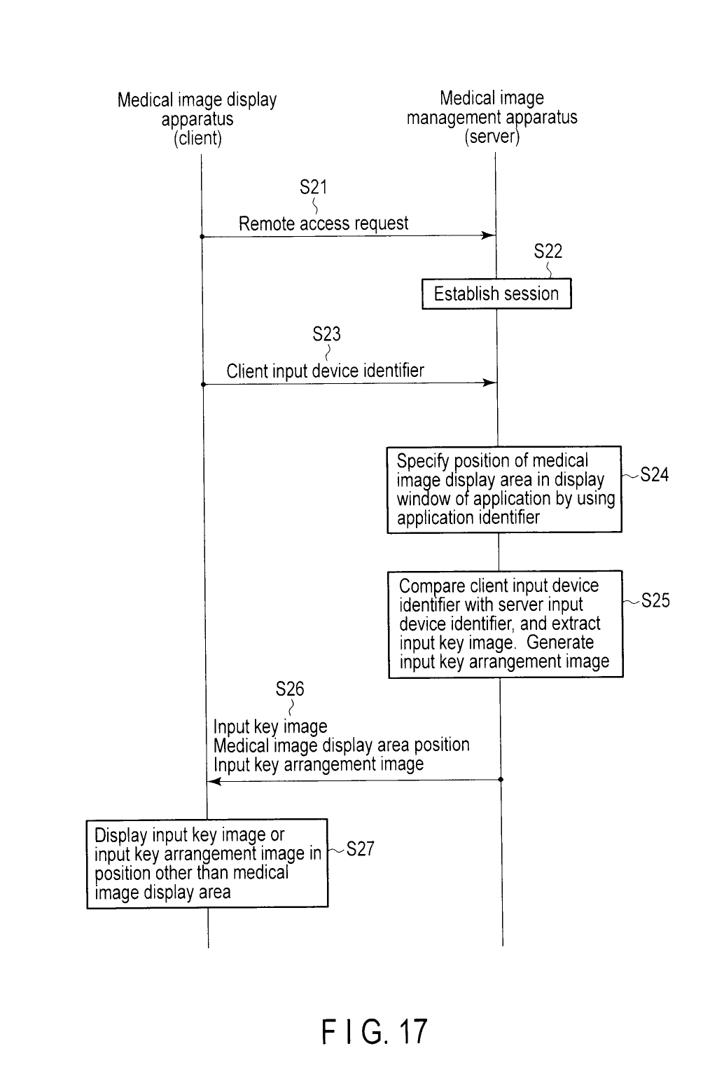

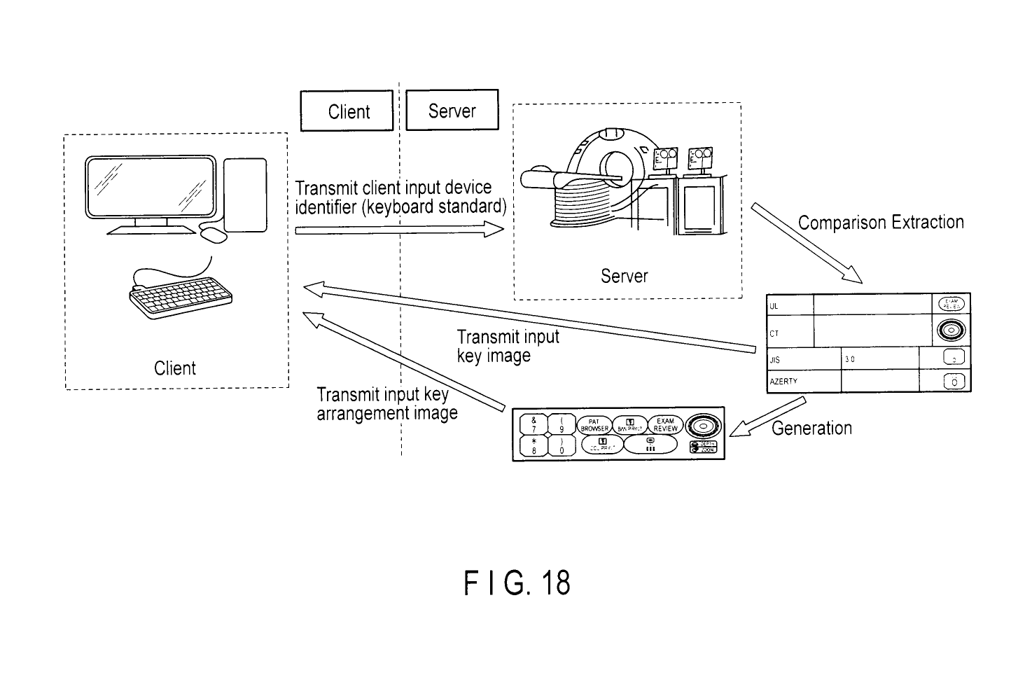

The following is explanation of an operation example of an input assistant system 1 according to the third embodiment. FIG. 17 is a diagram illustrating a flow of processing of the input assistant system 1 according to the third embodiment. FIG. 18 is a schematic diagram of the processing of the input assistant system 1 according to the third embodiment.

As illustrated in FIG. 17, the user performs login operation through the input unit 31 of the client 3. When the login operation is performed, the remote access unit 35 transmits a remote access request to the server 2 designated by the user (S21). When user's access is permitted, the user desktop management unit 22 establishes a login session for the user, and generates login session information (S22). While the communication session is held, the user desktop management apparatus 22 transmits screen image data of the user desktop to the client 3. The screen image data is received by the login session management unit 53. A screen image which corresponds to the received screen image data is displayed on a display unit 39.

After S22, the self information management unit 51 transmits the client input device identifier to the server 2 (S23). The transmitted client input device identifier is received by the self information management unit 41.

After S23, the specifying unit 37 reads out an application identifier of an application to be operated. The application identifier is managed by the self information management unit 41. The specifying unit 37 searches the medical image display position storing unit 34, by using the read application identifier as a searching key, and specifies a medical image display area position correlated with the searching key (S24).

After S24, the input key image generator 38 reads out the server input device identifier and the client input device identifier from the self information management unit 36. Then, the input key image generator 38 compares the server input device identifier with the client input device identifier, and extracts at least one input key image to be displayed from the input key image storing unit 33 (S25). When input key images are extracted, the input key image generator 38 may generate an input key arrangement image based on the input key images.

After S25, the self information management unit 41 transmits data of the medical image display area position and the input key image (S26). When an input key arrangement image is generated at S24, the self information management unit 41 transmits the input key arrangement image to the client 3. The transmitted medical image display area position data and the input key image and/or the input key arrangement image are received by the login session management unit 53.

After S26, the display unit 39 displays the input key image or the input key arrangement image in the input key image display area (S27). The input key image is displayed as GUI which can be operated by the input unit 31. The input key image display area is set by the display unit 39 according to the medical image display area position. The input key image display area is an area which is located on a window relating to the application in operation and in a position other than the medical image display area position.

The operation example of the input assistant system 1 according to the third embodiment is as described above.

According to the third embodiment, it is unnecessary for the client 3 to include the input key image storing unit 33 and the input key image generator 38, and thus it is possible to further reduce hardware resource of the client 3 in comparison with the first embodiment.

Therefore, according to the third embodiment, it is possible to improve convenience of input operation in the client in the thin client system.

### Fourth Embodiment

Each server 2 according to the second embodiment does not generate input key images. Each server 2 according to a fourth embodiment generates input key images. The following is explanation of servers and a client according to the fourth embodiment. In the following explanation, constituent elements which have almost the same functions as those in the second embodiment are denoted by the same respective reference numerals, and explained again only if necessary. Suppose that the client according to the fourth embodiment logs in servers through a network. Suppose that the number of servers which the client logs in is two for specifically performing the following explanation, although the number may be of any number. In addition, suppose that the servers according to the fourth embodiment are the same as the servers according to the third embodiment.

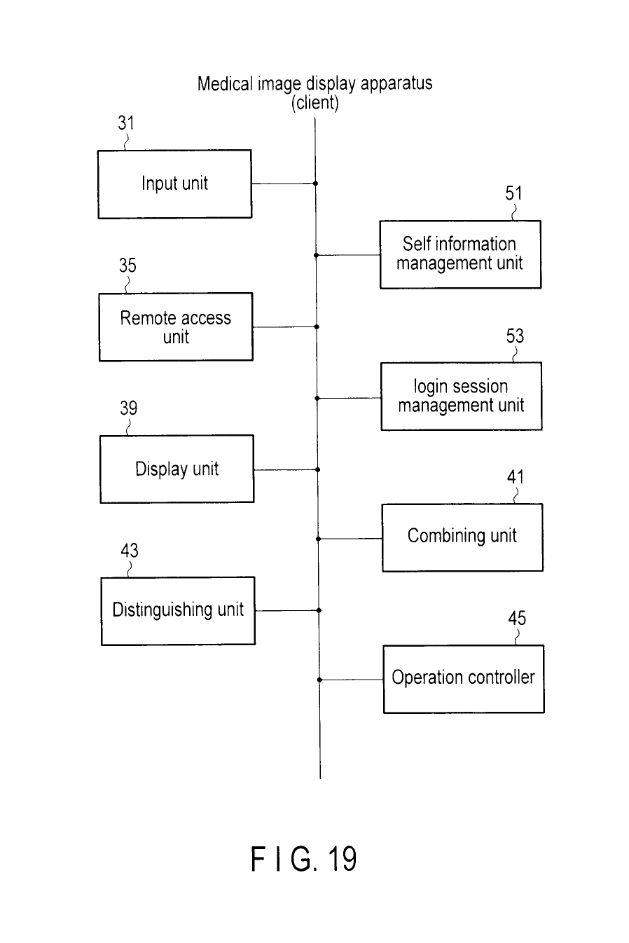

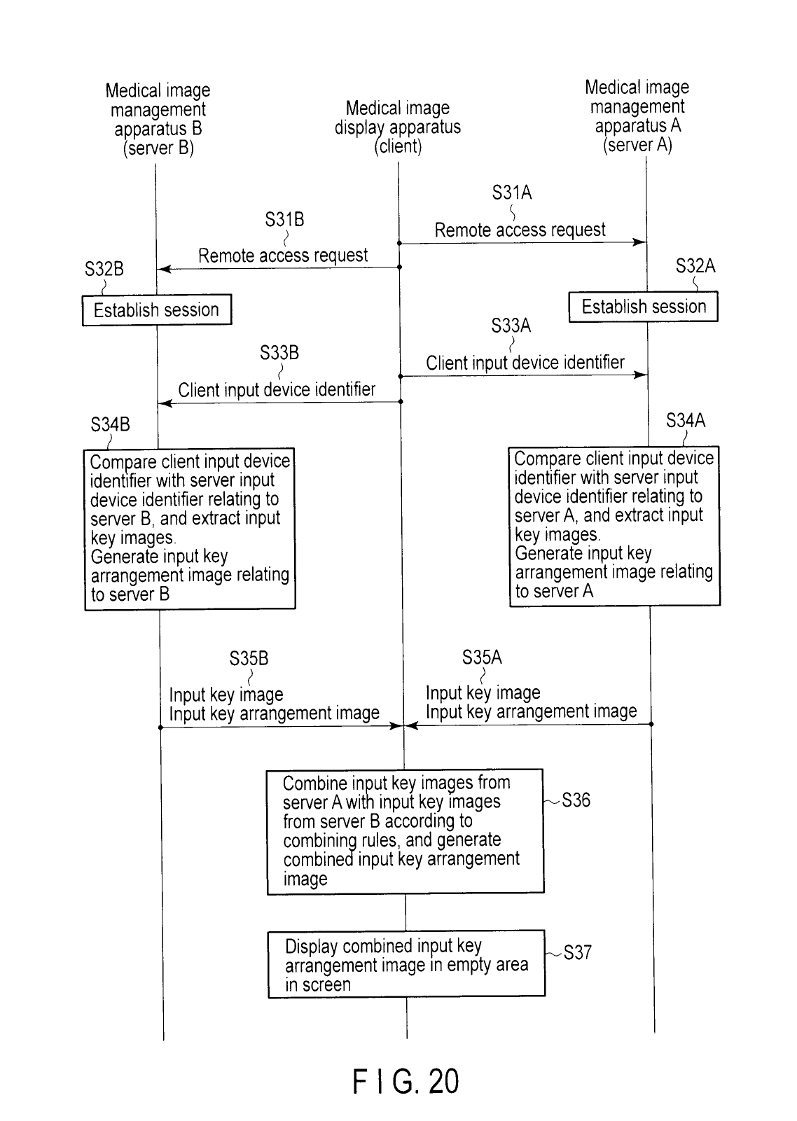

FIG. 19 is a diagram illustrating a structure of the client 3 according to the fourth embodiment. FIG. 20 is a diagram illustrating a typical flow of processing of an input assistant system 1 according to the fourth embodiment.

As illustrated in FIG. 20, the user performs login operation to the server A through an input unit 31 of the client 3. A remote access unit 35 transmits a remote access request to the server A (S31A). When user's access is permitted, a user desktop management unit 22 of the server A establishes a login session for the user, and generates login session information (S32A). While the communication session is held, the user desktop management apparatus 22 of the server A transmits screen image data of the user desktop relating to the server A to the client 3. The screen image data relating to the server A is received by a login session management unit 36. A screen image which relates to the server A and corresponds to the received screen image data is displayed on a display unit 39. After S32A, a self information management unit 51 of the client transmits a client input device identifier to the server A (S33A). The transmitted client input device identifier is received by a self information management unit 41 of the server A. After S33A, an input key image generator 38 of the server A reads out the server input device identifier relating to the server A and the client input device identifier from the self information management unit 41 of the server A. Then, the input key image generator 38 compares the server input device identifier relating to the server A with the client input device identifier, and extracts input key images to be displayed from an input key image storing unit 33 of the server A (S34A). In addition, the input key image generator 38 of the server A generates a first input key arrangement image which is based on the input key images and relates to the server A. After S34A, the self information management unit 41 of the server A transmits the input key images relating to the server A and the first input key arrangement image (S35A). The transmitted input key images and the first input key arrangement image are received by the login session management unit 53.

In parallel with login operation to the server A, the user performs login operation to a server B through the input unit 31 of the client 3. The remote access unit 35 transmits a remote access request to a server B (S31B). When user's access is permitted, a user desktop management apparatus 22 of the server B establishes a login session for the user, and generates login session information (S32B). While the communication session is held, the user desktop management apparatus 22 of the server B transmits screen image data of the user desktop relating to the server B to the client 3. The screen image data relating to the server B is received by the login session management unit 36. A screen image which relates to the server B and corresponds to the received screen image data is displayed on the display unit 39. After S32B, the self information management unit 41 of the client 3 transmits the client input device identifier to the server B (S33B). After S33B, an input key image generator 38 of the server B compares the server input device identifier relating to the server B with the client input device identifier, and extracts input key images to be displayed from an input key image storing unit 33 of the server B (S34B). In addition, the input key image generator 38 of the server B generates a second input key arrangement image which relates to the server B and is based on the input key images. After S34A, the self information management unit 41 of the server B transmits the input key images relating to the server B and the second input key arrangement image (S35B).

After S34A and S34B, a combining unit 41 of the client 3 combines the input key images from the server A with the input key images from the server B in accordance with combining rules (S35). For example, when a pair of the same input key images is included in the first input key arrangement image from the server A and the second input key arrangement image from the server B, combining processing is performed by the combining unit 41. The details of the combining processing is the same as the processing performed at S16 of the second embodiment, and explanation thereof is omitted.

After S35, the display unit 39 displays the combined input key arrangement image in an empty area in the display screen (S36). Thereby, the input key images included in the combined input key arrangement image are displayed.

The operation example of the input assistant system 1 according to the fourth embodiment is as described above.

According to the fourth embodiment, it is unnecessary for the client 3 to include the input key image storing unit 33 and the input key image generator 38, and thus it is possible to further reduce hardware resource of the client 3 in comparison with the second embodiment.

Therefore, according to the forth embodiment, it is possible to improve convenience of input operation in the client in the thin client system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image display apparatus which is connected to a medical image management apparatus through a network such that the medical image display apparatus is capable of logging in the medical image management apparatus, comprising:
an input device configured to include a first input key mounted to the medical image display apparatus;
a receiver configured to receive an input key image relating to a second input key mounted to the medical image management apparatus from the medical image management apparatus;
a display unit configured to display the received input key image;
an input unit configured to operate the displayed input key image in accordance with user's input operation, and generates an operation signal corresponding to the input operation; and
a transmitter configured to transmit the generated operation signal to the medical image management apparatus.

2. The apparatus of claim 1, wherein
the second input key is an input key which is peculiar to the medical image management apparatus and not mounted to the medical image display apparatus.

3. The apparatus of claim 1, wherein
the transmitter transmits an identifier of the input device to the medical image management apparatus through the network, and
the received input key image is a image that corresponds to an input key which is peculiar to the medical image management apparatus and not mounted to the medical image display apparatus.

4. The apparatus of claim 1, wherein
the display unit displays the input key image in a area other than a preset area in a display screen.

5. A medical image display apparatus which is connected to a medical image management apparatus through a network such that the medical image display apparatus is capable of logging in the medical image management apparatus, comprising:
an input device configured to include an input key;
a first storing unit configured to store a plurality of input key images relating to respective input keys, each of the input keys being associated with an identifier, the identifier including at least one of a type of a keyboard and a type of a device which includes the keyboard;
a receiver configured to receive a server identifier relating to an input device of the medical image management apparatus from the medical image management apparatus;
an extracting configured to extract an target input key image from the storing unit based on the received server identifier and a client identifier relating to the input device; and
a display unit configured to display the extracted target input key image.

6. The apparatus of claim 5, wherein
the target input key image is an input key image that corresponds to an input key which is mounted to the medical image management apparatus and not mounted to the medical image display apparatus.

7. The apparatus of claim 5, wherein
the display unit displays the input key image in a area other than a preset area in a display screen.

8. The apparatus of claim 5, further comprising:
an input unit which operates the input key image to be displayed in accordance with user's input operation, and generates an operation signal corresponding to the input operation; and
a transmitter which transmits the operation signal to the medical image management apparatus.

9. The apparatus of claim 5, wherein
the extracting unit generates, when the target input key image includes a plurality of input key images, an input key arrangement image including the input key images, and
the display unit displays the generated input key arrangement image.

10. The apparatus of claim 5, further comprising:
a second storing unit configured to store application identifiers in association with image display area positions in a display screen; and
a specifying unit configured to searches the second storing unit by using an application identifier of an application that is being executed by the medical image management apparatus as a searching key, and specifies an image display area position which is associated with the searching key,
wherein the display unit displays the target input key image in an area other than the specified area in the display screen.

11. A medical image display apparatus which is connected to a plurality of medical image management apparatuses through a network such that the medical image display apparatus is capable of logging in the medical image management apparatuses, comprising:
an input device configured to include a first client input key mounted to the medical image display apparatus;
a receiver configured to receive an first input key image relating to a first server input key mounted to a first medical image management apparatus among the medical image management apparatuses from the first medical image management apparatus, and a second input key image relating to a second server input key mounted to a second medical image management apparatus among the medical image management apparatuses from the second medical image management apparatus;
a display unit configured to display the received first input key image and the received second input key image;
an input unit configured to operate at least one of the displayed first input key image and the displayed second input key image in accordance with user's input operation, and generates an operation signal corresponding to the input operation; and
a transmitter configured to transmit the generated operation signal to a medical image management apparatus which has transmitted the operated input key image among the first medical image management apparatus and the second medical image management apparatus.

12. The apparatus of claim 11, further comprising:
a generator configured to generates, when the receiver receives a plurality of first input key images and a plurality of second input key images, a single input key arrangement image based on the first input key images and the second input key images,
wherein the display unit displays the generated input key arrangement image.

13. The apparatus of claim 12, wherein
when the first input key images and the second input key images include two input key images of the same type, the generator combines the two input key images into an input key image.

14. The apparatus of claim 11, further comprising:
a generator configured to generate, when the receiver receives a plurality of first input key images and a plurality of second input key images, a first input key arrangement image based on the first input key images, and generates a second input key arrangement image based on the second input key images,
wherein the display unit displays the generated first input key arrangement image and the generated second input key arrangement image side by side.

15. The apparatus of claim 14, wherein
the receiver receives first screen image data from the first medical image management apparatus, and receives second screen image data from the second medical image management apparatus, and
the display unit displays a first screen image which corresponds to the first screen image data, and a second screen image which corresponds to the second screen image data, and displays the first input key arrangement image and the second input key arrangement image in arrangement in accordance with vertical or horizontal arrangement of the first screen image and the second screen image.

16. The apparatus of claim 15, wherein
the display unit displays the first input key arrangement image close to the first screen image, and displays the second input key arrangement image close to the second screen image.

17. The apparatus of claim 11, further comprising:
a generator which has a first function of, when the receiver receives a plurality of first input key images and a plurality of second input key images, generating a combined input key arrangement image based on the first input key images and the second input key images, and a second function of generating a first input key arrangement image based on the first input key images and generating a second input key arrangement image based on the second input key images,
wherein the display unit displays the combined input key arrangement image when the first function is performed, and displays the first input key arrangement image and the second input key arrangement image side by side when the second function is performed, and
the first function and the second function are selectable in accordance with a user's instruction.

18. The apparatus of claim 11, wherein
the receiver receives first screen image data from the first medical image management apparatus, and receives second screen image data from the second medical image management apparatus, and
the display unit displays a first screen image which corresponds to the received first screen image data, and displays a second screen image which corresponds to the received second screen image data.

19. The apparatus of claim 18, further comprising:
a distinguishing unit configured to distinguish a medical image management apparatus in which the medical image display apparatus operates, among the first medical image management apparatus and the second medical image management apparatus,
wherein the display unit visually emphasizes a screen image which corresponds to the medical image management apparatus in operation, among the displayed first screen image and the second screen image.

20. The apparatus of claim 18, further comprising:
a distinguishing configured to distinguish a medical image management apparatus in which the medical image display apparatus operates from a medical image management apparatus in which the medical image display apparatus does not operate, among the first medical image management apparatus and the second medical image management apparatus,
wherein the display unit visually emphasizes the input key image from the medical image management apparatus in operation, and visually suppresses the input key image from the medical image management apparatus not in operation, among the first input key image and the second input key image.

21. The apparatus of claim 18, further comprising:
a distinguishing unit configured to distinguish a medical image management apparatus in which the medical image display apparatus operates from a medical image management apparatus in which the medical image display apparatus does not operate, among the first medical image management apparatus and the second medical image management apparatus; and
a controller which nullifies input operation for an input key image which corresponds to an input key mounted only to the medical image management apparatus not in operation, among the first input key image and the second input key image.

22. The apparatus of claim 18, further comprising:
a selector configured to select one of the first screen image and the second screen image in accordance with a user's instruction,
wherein the display unit displays an input key image which relates to the selected screen image, among the first input key image and the second input key image.

23. The apparatus of claim 22, wherein
the display unit does not display an input key image which relates to a screen image which is not selected by the selector, among the first input key image and the second input key image.

24. A medical image management apparatus which is connected to a medical image display apparatus through a network, comprising:
a first storing unit configured to store a plurality of input key images relating to respective input keys, an each of the input key images being associated with an identifier, the identifier including at least one of a type of a keyboard and a type of a device which includes the keyboard;
an input device configured to include a first input key mounted to the medical image management apparatus;
a receiver configured to receive a client identifier relating to a second input key mounted to the medical image display apparatus from the medical image display apparatus;
an extracting unit configured to extract a target input key image from the storing unit based on the received client identifier and a server identifier relating to the input device; and
a transmitter configured to transmit the extracted target input key image to the medical image display apparatus.

25. The medical image management apparatus of claim 24, wherein
the target input key image is an input key image that relates to an input key which is peculiar to the medical image management apparatus and not mounted to the medical image display apparatus.

26. The apparatus of claim 24, further comprising:
a generator configured to generate, when the extracting unit extracts a plurality of input key images, an input key arrangement image including the first input key images,
wherein the display unit displays the generated input key arrangement image.

27. The apparatus of claim 24, further comprising:
a second storing configured to store application identifiers in association with image display area positions in a display screen; and
a specifying unit configured to search the second storing unit by using an application identifier of an application that is being executed by the medical image management apparatus as a searching key, and specifies an image display area position which is associated with the searching key,
wherein the transmitter transmits information relating to the specified position to the medical image display apparatus.
